(19) United States
(12) Patent Application Publication
(10) Pub. No.: US 2020/0307662 A1
(43) Pub. Date: Oct. 1, 2020

(54) DATA FUSION CONCEPT

(71) Applicant: KONUX GMBH, München (DE)

(72) Inventors: Christian BRANDLHUBER, München (DE); Vlad Ilie LATA, München (DE); Dennis HUMHAL, München (DE); Andreas KUNZE, München (DE); Maximilian HASLER, München (DE)

(21) Appl. No.: 16/759,848

(22) PCT Filed: Oct. 30, 2017
(86) PCT No.: PCT/EP2017/077755

§ 371 Date: Apr. 28, 2020

(51) Int. Cl. B61L 23/04; B61L 27/00; G06N 20/00

(52) U.S. Cl. CPC B61L 23/042; G06N 20/00; B61L 27/0088

(57) ABSTRACT

The present invention relates to a system for monitoring at least one characteristic of a railroad (10), comprising a central computing unit (22) which is adapted to retrieve and process data from multiple data sources (19, 20, 24, 26) and to provide output data representing the at least one characteristic of the railroad (10), and at least two data sources (19, 20, 24, 26) which are adapted to deliver data to the central computing unit over respective data links, wherein at least one of the two data sources (19) comprises at least one sensor unit (16a-16c) located in the vicinity of a section of the railroad (10) to be monitored. According to the invention, the at least two data sources (19, 20, 24, 26) are provided such that said data delivered by them refers to different physical properties of the railroad (10) and/or environmental properties.

The present invention relates to a system for monitoring at least one characteristic of a railroad, comprising a central computing unit which is adapted to retrieve and process data from multiple data sources and to provide output data representing the at least one characteristic of the railroad, and at least two data sources which are adapted to deliver data to the central computing unit over respective data links, wherein at least one of the two data sources comprises at least one sensor unit located in the vicinity of a section of the railroad to be monitored. Furthermore, the present invention relates to a method for monitoring at least one characteristic of a railroad using such a system.

It is known in the art to monitor sections of railroads such as turnouts or other sections which are susceptible to wear using sensors attached to the rail tracks themselves or to crossties between the rails. Said sensors measure physical properties such as the acceleration of the components to which the sensors are attached. Data representing the measured observables are then forwarded to a central computing unit which further processes the raw data delivered by the sensors. However, the data provided in such systems is rather crude and it is not possible to take into account complex correlations between the data taken by the sensors and other environmental or railroad-related effects. The monitoring provided by such systems is therefore often not very reliable.

It is one of the achievements of the inventors of the present invention to have come to realize that by employing the concept known as “data fusion” in the context of monitoring characteristics of railroads, much more sophisticated, integrated and reliable predictions and conclusions can be made on the current state of a railroad and its relevant characteristics by fusing data provided by at least two data sources.

Therefore, in the system according to the present invention the at least two data sources are provided such that said data delivered by them refers to different physical properties of the railroad and or environmental properties. By integrating different physical properties of the railroad and/or properties of the environment of the railroad, arbitrarily complex correlations between the observed physical properties and the current state of the railroad and its at least one observed characteristic can be drawn.

One very simple beneficial example of data fusion in the context of monitoring railroads, yet already a significant improvement over the mere use of acceleration sensors described above, is to use at least one temperature sensor as a secondary data source together with the acceleration sensors located in the vicinity of a section of the railroad such as on a crosstie. By taking into account the air temperature or even the temperature of the railroad tracks themselves, a better understanding of the tension in the tracks due to thermal expansion is achieved, which can be accounted for in the processing of the acceleration data provided by the primary data source, i.e. the acceleration sensors. This way, a vastly improved understanding of the health state of the railroad section under observation can be achieved with justifiable additional effort.

From this example, the beneficial basic principle of the present invention can be understood. By deriving a single characteristic of a railroad from at least two incommensurable data sources relying on different observables or physical properties and employing suitable algorithms, such as stochastic filters based on hidden Markov chains, in order to fuse said incommensurable data, the sensor characteristics of the different data sources can be compensated, such that a final result representing the characteristic of the railroad in question can be derived with a higher quality than could be achieved by any single sensor.

The central computing unit may be implemented in any known manner as long as reliable data links to the data sources can be provided, for example as a mainframe computer or a cloud-based hardware-as-a-service design. Sophisticated algorithms and/or data bases can be employed by the central computing unit in order to derive precise and reliable information about the at least one characteristic of the railroad. While also the data sources can also be implemented in a wide variety of ways, they can typically include one or more sensors or have access to data from a data base as well as the capability to establish a data link with the central computing unit. However and as will be discussed below, the data sources may also be of much more complex design and may themselves comprise computing units, such as microcontrollers or the like, with significant processing power.

In this context, at least one of the data sources of the system according to the invention may comprise a pre-processing unit which is adapted to pre-process the data prior to delivering it to the central computing unit. In contrast to the above-described system known from the art which relies on the principals of the so-called “cloud computing” in which sensors simply provide their recorded data to a central computing unit which is responsible for all aspects of data processing, the present invention may employ a so-called “fog computing” or “edge computing” approach in which the data sources themselves are intelligent to a certain degree. Thus, a significant amount of the data processing in the system according to the invention can be relocated from the central computing unit to the pre-processing units of the data sources which can have numerous benefits over known concepts.

First of all, the data to be sent to the central computing unit can in many cases be substantially reduced by suitable data compression or data filtering algorithms, for example by providing highly specialized and in some cases even hardwired pre-processing units at the data sources. Since these pre-processing units can be specially designed for their very particular data processing operations, a significant gain in computing efficiency can be achieved already at the lowest level of data handling. In some cases and as already mentioned, the raw signals may be filtered and only data found relevant may be forwarded to the central computing unit, while alternatively or additionally the data may be encoded in data formats with high compression ratios. This can lead to a substantial reduction of the bandwidth necessary in the data links which may lead to reduced energy consumption and higher reliability of the system among other benefits.

Even though a wide array of data sources can be used in the system according to the invention, in order to be able to rely on the most basic physical properties of the railroad itself and to include them in the data fusion processes performed by the central computing unit of the system, it can be beneficial if at least one of the sensor units is disposed at a crosstie of the railroad to be monitored. Said crossties offer ideal conditions for disposing sensor units upon them since they are an intimate connection with the tracks themselves, yet trains riding on the tracks still have a sufficient distance to them in order not to damage the sensors or to cause overly non-linear effects during data taking.

In certain embodiments, at least one of the sensor units located in the vicinity of a section of the railroad may be arranged to sense an acceleration, a velocity and/or a position of said section and/or may be an acceleration sensor, optical sensor, acoustical sensor, ultra-sound sensor, electrical and/or magnetic sensor or temperature sensor. Said sensor units may further be arranged to provide their data at regular time intervals or based on internal or external trigger events.

Alternatively or additionally at least one of the data sources providing data referring to environmental properties may be arranged to provide weather data or railroad timetable data. Said data sources may either generate such data themselves, such as by evaluating and forwarding current travel and position information about trains using the railroad in question thus creating a railroad timetable, or using data retrieved from other sources, such as cloud-based weather services, which they may pre-process before delivering it to the central computing unit for further use.

Furthermore, at least one of the data sources may comprise an interface for manually inputting data. Such data can refer to arbitrary types of input observables, for example results of optical inspections of the railroad performed by trained human operators may be input in a suitable format and subsequently provided to the central computing unit for further processing and fusing with data provided by other data sources.

It can be understood from the types of sensor units mentioned above as well as from the physical properties said sensors are arranged to sense that the data fusion concept of the present invention may be used with a wide array of physical or environmental properties of the railroad and its environment and even manually input data which may refer to optical inspections of the railroad or the like can be integrated natively.

Furthermore, it may be beneficial if the data link between the central computing unit and at least one of the data sources is bi-directional. Such bi-directional links allow a data transmission not only from the data sources to the central computing unit but also vice versa and can be beneficially used in many scenarios. For example, if the monitoring of the at least one characteristic of a railroad shows a problematic behavior of a certain data source, the central computing unit may instruct the data source to perform a self-diagnosis or provide data at a higher rate in order to verify the observed behavior. Also, by establishing bi-directional data links, the data sources may be provided with upgrades such as improved pre-processing algorithms and the like.

According to a further development utilizing the bi-directional data links, the central computing unit may further be adapted to selectively activate one or more of the data sources by switching them from a standby mode to a data-providing mode. Said selective switching the data sources into an activated state and subsequently after their providing of data or an elapsing of a predetermined time span switching them back into a deactivated state contributes to saving energy and reducing bandwidth requirements of the system according to the invention. The conditions for the selective activation of the data sources may be based on regular time intervals, expected occurrences of events such as the passage of a train by a certain sensor unit or any other suitable condition. Said conditions may further be updated in real-time, such as discussed above by providing the data sources with corresponding instructions.

Alternatively or additionally, at least one of the data sources may be adapted to switch from a standby mode to a data-providing mode based on at least one activation condition. Said activation condition may as well be based on a regular time interval such that the data source itself has to be provided with a clock or by the occurrence of certain triggering conditions such as a physical property being sensed by a sensor unit of the data source exceeding a predetermined threshold value of the observable in question.

Furthermore, the central computing unit and/or at least one of the data sources may further be adapted to store and provide historical data. By having such historical data available, time developments of the relevant characteristics of the railroad can be monitored, such that for example aging processes of the railroad which are represented in changes of its characteristics over time can be understood and compared with an expected behavior.

The concept of fog computing employed in the present invention allows for at least one of the data sources having a hierarchical structure comprising multiple sub-sources and an upper layer, wherein the upper layer may be adapted to collect and possibly pre-process data from the multiple sub-sources and to provide the collected and pre-processed data to the central computing unit. One possible embodiment of such a hierarchical structure may be a data source comprising a multitude of sensor units with a common pre-processing unit which collects and pre-processes the data provided by the sensor units and only after pre-processing it, which may for example comprise a compressing of the data, in turn provides it to the central computing unit. In such embodiments, the necessary processing power and effort may be split between the layers of the hierarchical structure of the data source and the central computing unit in any suitable manner.

According to the invention, at least two of the data sources or data sub-sources may be provided such that the data delivered by them refers to different or partially overlapping ranges of a common observable. This principle of sensing different ranges of a common observable by different data sources, different data sub-sources or different sensor units is sometimes referred to as “sensor fusion” and may contribute to providing highly accurate data over a wide range of the observable by employing specialized sensors for the respective ranges of the observable, the data of which is subsequently combined or fused.

In another further development of the present invention, at least one additional data link may be provided between a pair or group of data sources. Said additional data links may for example beneficially be used in the above-mentioned selective activation of the data sources, e.g. if from the occurrence of an event at one data source it can be concluded that within a certain time window an event is expected to occur at another data source, said another data source may be put into data-providing mode for a predetermined time window around the expected event. In practice, for example one data source registering the passage of a train at its location may trigger the activation of a further data source down the railroad in the travelling direction of the train. Furthermore, the data links between the data sources may be employed for low-level diagnosis procedures or consistency checks between the individual data sources without the necessity of a diversion over the central computing unit.

Depending on the respective implementation and positioning of the individual data sources as well as the central computing unit, it may be beneficial if at least of the data links between the central processing unit and at least one of the data sources and/or between pairs or groups of data sources is of a wireless type. Even though a dedicated wireless protocol may be developed for the system according to the present invention, known standards for wireless data transmission may as well be used, such as cellular or Bluetooth technology, depending on the required range and bandwidth of the individual data links. On the other hand, wire-based data links may be used as well, again depending on the respective implementation and positioning of the individual data sources within the system and relative to the railroad to be monitored.

As indicated above, according to a second aspect, the present invention furthermore relates to a method for monitoring at least one characteristic of a railroad using a system according to the invention and comprising the steps of:
by the central computing unit, retrieving data from the multiple data sources, and
processing the retrieved data according to predetermined instructions.

Said instructions may comprise any suitable algorithm, employ data bases and any other data processing techniques which are suitable for monitoring characteristics of railroads.

Furthermore, the method according to the invention may comprise storing historical data by the central computing unit and/or at least one of the data sources in order to monitor time developments and have historical data readily available for different kinds of algorithms.

According to a further development, the method according to the invention may comprise machine learning steps, according to which the predetermined instructions for processing the retrieved data may be modified. For this purpose, known techniques such neural networks or genetic algorithms may be used.

As already mentioned above, the at least one characteristic to be monitored may be a wear state or a health state of the railroad or a section thereof and/or the monitoring of the at least one characteristic of a railroad may comprise a generating of a multidimensional virtual model of the railroad or a section thereof, for example for data presentation or data processing purposes.

As also already mentioned above, the method according to the invention may comprise a pre-processing step which is performed by at least one of the data sources on the data to be delivered to the central computing unit, wherein said pre-processing step preferably comprises a reduction of the volume of the data.

One very practical and easy to implement technique for said reduction of the volume of the data may be to comprise an evaluation of the data in the pre-processing step concerning at least one trigger condition, such that only when at least one of the trigger conditions is fulfilled, data is delivered to the central computing unit.

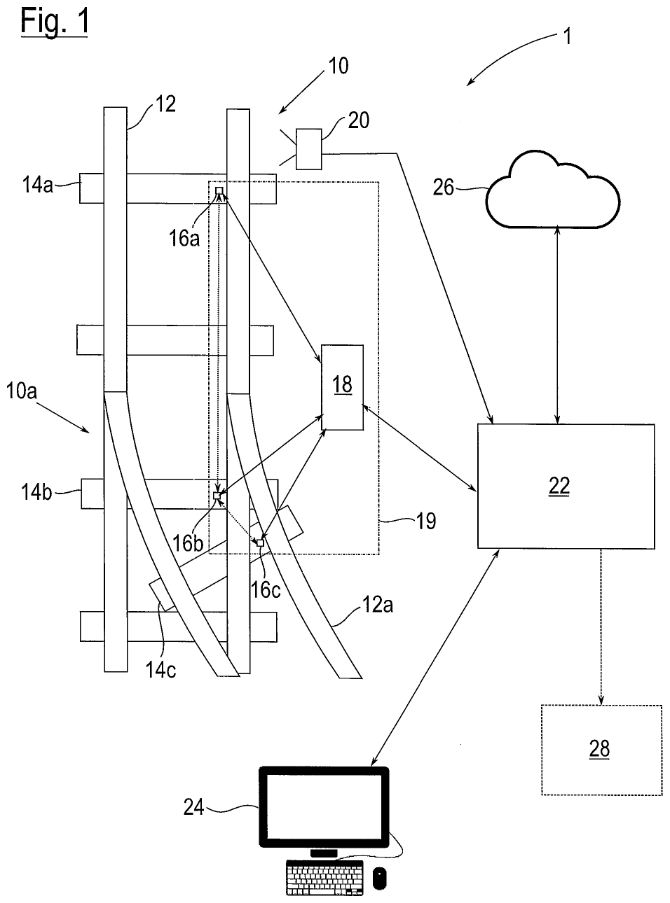

Additional features and beneficial effects of the present invention will be understood from the following description of an embodiment of the invention when it is viewed together with attached FIG. 1. Said FIG. 1 shows a schematic representation of an embodiment of a system according to the invention, generally denoted with the reference numeral 1.

Said system 1, as shown in FIG. 1, is arranged to monitor at least one characteristic of railroad 10 of which in FIG. 1 a section comprising a turnout 10a is schematically shown. At the turnout 10a a first pair of tracks 12 of the railroad 10 meets with a second pair of tracks 12a such that a train may be guided from track 12 to track 12a or remain on track 12 based on the operation condition of the turnout.

Furthermore, FIG. 1 shows multiple cross ties 14a to 14c which are associated with the first or second tracks 12, 12a. Positioned on the cross ties 14a to 14c are respective acceleration sensors 16a to 16c measuring the acceleration of the crossties 14a to 14c at the time of a passage of a train, which can be an indicator for the wear or health state of the railroad 10 around their respective positions. Thus, these sensors 16a to 16c correspond to the sensor units positioned in the vicinity of the railroad 10 in the sense of the present invention.

As indicated by continuous lines, said acceleration sensors 16a to 16c are in data connection with a common computing unit 18 to which they provide their acceleration data taken at their respective positions. Thus, the acceleration sensors 16a to 16c together with their common computing unit 18 form a hierarchical data source 19 according to the invention which in turn is in data connection with the central computing unit 22 of the system 1. The common computing unit 19 performs a “low-level” data fusion employing stochastic filtering techniques based on hidden Markov chains by means of which the quality of the individual measurements of the sensor units 16a to 16c can be improved by compensating for their measurement errors.

As indicated by the arrows in FIG. 1 all data links between the respective acceleration sensors 16a to 16c and the common computing unit 18 are bi-directional and further bi-directional data links are also provided between pairs of the acceleration sensors 16a to 16c themselves, which are indicated by dashed lines. Thus, for example when a train passes the turnout 10a shown in FIG. 1 in a direction from top to bottom, as soon as the first acceleration sensor 16a registers the passage of the train by the measured acceleration exceeding a predetermined trigger threshold value, it may send an activation signal to the second acceleration sensor 16b since within a given time window, a passage of the train at the position of the second acceleration sensor 16b can be expected.

System 1 shown in FIG. 1 furthermore comprises multiple other data sources including environmental sensors such as a temperature, optical or acoustical sensor 20 which is arranged to detect the temperature or optical or acoustical events in the vicinity of the railroad 10. Said environmental data is then also provided to the central computing unit 22 which can further retrieve data from cloud-based data sources 26, for example representing weather or railroad timetable data, as well as from data sources 24 for manually inputting arbitrary additional data such as data based on optical inspections of the railroad 10 performed by a human operator.

It should further be noted that the data sources themselves may in some cases be capable of performing a pre-processing of the data collected by their respective sensor units, for example for reducing the amount of data to be transferred to the central computing unit 22 via the data links by employing triggering, filtering and/or encoding algorithms.

Ultimately, the central computing unit 22 will perform data fusion algorithms on the data available from the different data sources 19, 20, 24 and 26 in order to predict and evaluate wear and heath states of the railroad 10 in order to facilitate and optimize maintenance work and the like. Thus, the central computing performs a “high-level” data fusion process, in which data on the use and environment of the railroad 10 are fused with concrete measurements of physical properties of the railroad 10, for example provided by the data source 19.

The central computing unit 22 may for this purpose be adapted to either output data on the relevant characteristics of the railroad 10 in a human-readable form to human operators which can subsequently perform necessary tasks, or it may provide its results to a superordinate integrated system 28 which can automatically trigger any necessary maintenance steps or any other suitable action. In this context, the central computing unit 22 may further be arranged to generate a multidimensional virtual model of the railroad 10 in order to diagnose possible disruptions or evaluate the state of the turnout 10a.

Lastly, the central computing unit 22 may be adapted to perform machine learning techniques, for example using neural networks and relying on feedback data providing it with measured quantities against which its predictions can be tested and from which its algorithms can be improved.

1. System for monitoring railroad characteristic(s), comprising:
a central computing unit which is adapted to retrieve and process data from multiple data sources and to provide output data representing the characteristic of the railroad;
two or more data sources which are adapted to deliver data to the central computing unit over respective data links,
wherein at least one of the data sources comprises one or more sensor unit(s) located in the vicinity of a section of the railroad to be monitored;
wherein the data sources are provided such that said data delivered by them refers to different physical properties of the railroad and/or environmental properties.

2. System according to claim 1, characterized in that the data source comprises a pre-processing unit which is adapted to pre-process the data prior to delivering it to the central computing unit.

3. System according to claim 1, wherein the sensor unit is disposed at a crosstie of the railroad to be monitored.

4. System according to claim 1, wherein the sensor units located in the vicinity of a section of the railroad is arranged to sense an acceleration, velocity and/or position of said section and/or is an acceleration sensor, optical sensor, acoustical sensor, ultra-sound sensor, electric and/or magnetic sensor or temperature sensor.

5. System according to claim 1, wherein the data sources providing data referring to environmental properties is arranged to provide weather data or railroad timetable data.

6. System according to claim 1, wherein the data source comprises an interface for manually inputting data.

7. System according to claim 1, wherein the data link between the central computing unit and at least one of the data sources is bi-directional.

8. System according to claim 7, wherein the central computing unit is further adapted to selectively activate the data sources by switching it from a stand-by mode into a data-providing mode.

9. System according to claim 1, wherein the data source is further adapted to switch from a stand-by mode into a data-providing mode based on an activation condition.

10. System according to claim 1, wherein the central computing unit and/or the data sources is further adapted to store and provide historical data.

11. System according to claim 1, wherein the data source has a hierarchical structure comprising multiple sub-sources and an upper layer, wherein the upper layer is adapted to collect and pre-process data from the multiple sub-sources and to provide pre-processed data to the central computing unit.

12. System according to claim 1, wherein the data sources or data sub-source is provided such that said data delivered by them refers to different or partially overlapping ranges of a common observable.

13. System according to claim 1, wherein an additional data link is provided between a pair or group of data sources.

14. System according to claim 1, wherein the data link between the central computing unit and the data sources and/or between pairs or groups of data sources is of a wireless type.

15. Method for monitoring a characteristic of a railroad using a system according to claim 1, comprising the steps of:
by the central computing unit, retrieving data from the multiple data sources; and
processing the retrieved data according to predetermined instructions.

16. Method according to claim 15, wherein it further comprises storing historical data by the central computing unit and/or at least one of the data sources.

17. Method according to claim 15, wherein it further comprises machine learning steps, in which the predetermined instructions are modified, for example using a neural network.

18. Method according to claim 15, wherein the characteristic to be monitored is a wear state or a health state of the railroad or a section thereof.

19. Method according to claim 15, characterized in that monitoring the characteristic of the railroad comprises generating a multi-dimensional virtual model of the railroad or a section thereof.

20. Method according to claim 15, wherein it comprises a pre-processing step which is performed by the data source on the data to be delivered to the central computing unit.

21. Method according to claim 20, wherein the pre-processing step comprises an evaluation of the data concerning at least one trigger condition, such that only when at least one of the trigger conditions is fulfilled data is delivered to the central computing unit.
